(19) United States
(12) Patent Application Publication
(10) Pub. No.: US 2012/0200095 A1
(43) Pub. Date: Aug. 9, 2012

(54) TUBULAR LEVER LOCK

(75) Inventors: ZHI-QIANG WANG, TIANJIN (CN); XIU-FENG LIU, TIANJIN (CN)

(73) Assignee: EVERSAFETY PRECISION INDUSTRY (TIANJIN) CO., LTD., TIANJIN (CN)

(21) Appl. No.: 13/023,661

(22) Filed: Feb. 9, 2011

(51) Int. Cl. E05C 1/10

(52) U.S. Cl. 292/143

(57) ABSTRACT

A tubular lever lock has a lock body and a bolt connected to each other, an interior handle assembly, an exterior handle assembly, an interior button assembly connected to the interior handle assembly and the lock body, and an exterior clutch assembly connected to the exterior handle assembly and the lock body. Position of an adjusting tube relative to a driving rod of the interior button assembly is adjustable to allow the tubular lever lock to match a thickness of a door. A pressing panel and a transmission tube of the exterior clutch assembly are able to disengage from each other so the exterior handle assembly is unable to drive the lock body.

### BACKGROUND OF THE INVENTION

1. Field of the Invention

The present invention relates to a tubular lever lock, especially to a tubular lever lock that has adjustable length to match a thickness of a door, and an exterior lever whose elements are capable of disengaging from each other to prevent the tubular lever lock from being unlocked from the exterior lever.

2. Description of the Prior Art(s)

A conventional lever lock with long levers is mounted on a door and has an exterior handle assembly and an interior handle assembly. The exterior and interior handle assemblies are connected to a lock body and lock or unlock the door through a bolt. The exterior handle assembly has an exterior lever mounted on an exterior surface of the door, and a lock core mounted in the exterior lever and connected to the lock body. The interior handle assembly has an interior lever mounted on an interior surface of the door, and a button mounted on the interior lever and connected to the lock body. Thus, when a user standing by the interior surface of the door turns or pushes the button, the exterior lever is locked and is unable to drive the bolt. Consequently, without a key to the lock core, people standing by the exterior surface of the door are unable to open the door.

However, a distance between the button and the lock body is fixed and is unable to be adjusted according to a thickness of the door. Thus, when the door is thinner than normal, the button may protrude out from the interior lever. When the door is thicker than normal, the button may be recessed in the interior lever. Therefore, it is inconvenient for the user to turn or push the button, and the conventional lever lock has an unsightly appearance. Moreover, if the user tries to change or replace elements of the conventional lever lock in order to allow the conventional lever lock to match the thickness of the door, it is very likely to damage the elements of the conventional lever lock and break down the conventional lever lock.

To overcome the shortcomings, the present invention provides a tubular lever lock to mitigate or obviate the aforementioned problems.

### SUMMARY OF THE INVENTION

The main objective of the present invention is to provide a tubular lever lock. The tubular lever lock has a lock body, a bolt connected to the lock body, an interior handle assembly and an exterior handle assembly connected to the lock body, an interior button assembly connected to the interior handle assembly and the lock body, and an exterior clutch assembly connected to the exterior handle assembly and the lock body.

The interior button assembly has an adjusting tube and a driving rod mounted in the adjusting tube. Position of the adjusting tube relative to the driving rod is adjustable to match a thickness of a door having the tubular lever lock.

The exterior clutch assembly has a pressing panel and a transmission tube that are able to disengage from each other so an exterior lever of the exterior handle assembly is unable to drive the lock body. Thus, the tubular lever lock is not broken easily and an endurance of the tubular lever lock device is prolonged for an improved lock performance.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a tubular lever lock in accordance with the present invention;

FIG. 2 is a partially exploded perspective view of the tubular lever lock in FIG. 1;

FIG. 3 is a side view in partial section of the tubular lever lock in FIG. 2;

FIG. 4 is a cross-sectional end view of the tubular lever lock in FIG. 2;

FIG. 5 is another partially exploded perspective view of the tubular lever lock in FIG. 1;

FIG. 6 is a side view in partial section of the tubular lever lock in FIG. 5; and

FIG. 7 is an end view of the tubular lever lock in FIG. 5.

### DETAILED DESCRIPTION OF THE PREFERRED EMBODIMENTS

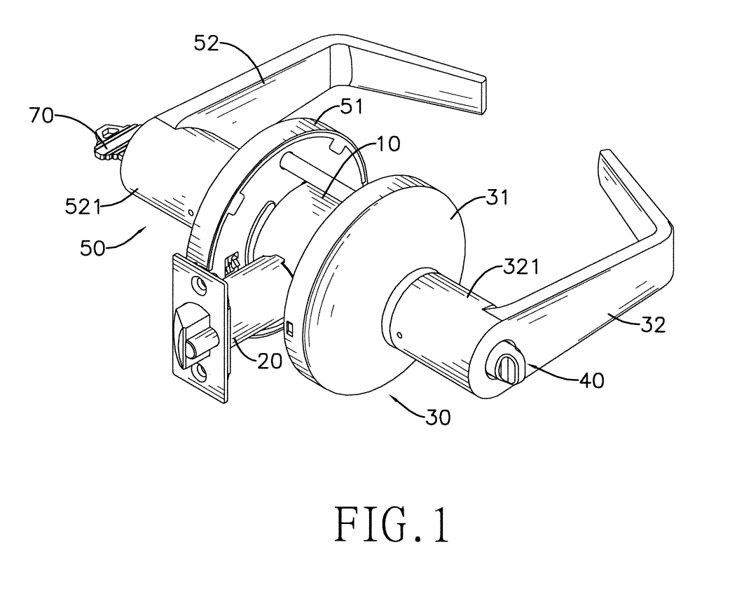

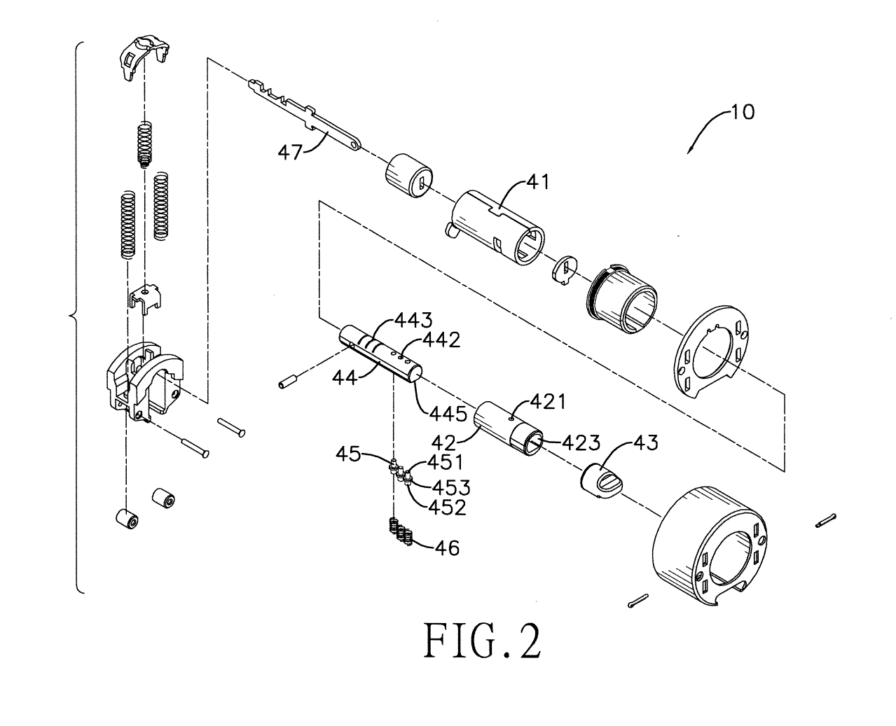

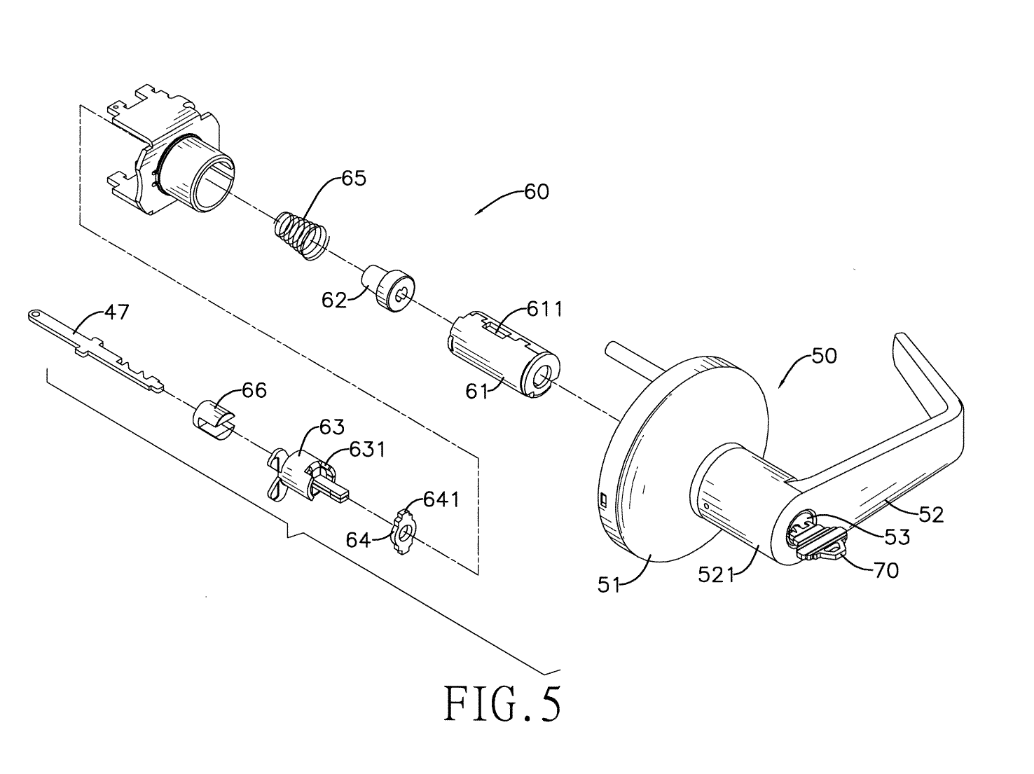

With reference to FIGS. 1, 2 and 5, a tubular lever lock in accordance with the present invention comprises a lock body 10, a bolt 20, an interior handle assembly 30, an interior button assembly 40, an exterior handle assembly 50 and an exterior clutch assembly 60.

The lock body 10 is mounted in a door. The bolt 20 is mounted on a peripheral surface of the door, is connected to the lock body 10 and selectively locks the door.

The interior handle assembly 30 is connected to the lock body 10, is mounted on an interior surface of the door and has an interior cap 31 and an interior lever 32. The interior cap 31 is mounted securely on the interior surface of the door, corresponds to the lock body 10 and has a mounting hole formed through the interior cap 31. The interior lever 32 is mounted on an outer surface of the interior cap 31 and has a mounting tube 321. The mounting tube 321 protrudes transversely from an end of the interior lever 32 and is concentric with and communicates with the mounting hole of the interior cap 31.

The interior button assembly 40 is mounted in the interior handle assembly 30, is connected to the lock body 10 and the interior lever 32, and has an interior driving tube 41, an adjusting tube 42, a button 43, a driving rod 44, multiple positioning pins 45, multiple resilient elements 46 and a lock rod 47.

The interior driving tube 41 is tubular, is mounted through the mounting hole of the interior cap 31 and is connected to the mounting tube 321 of the interior lever 32 and the lock body 10.

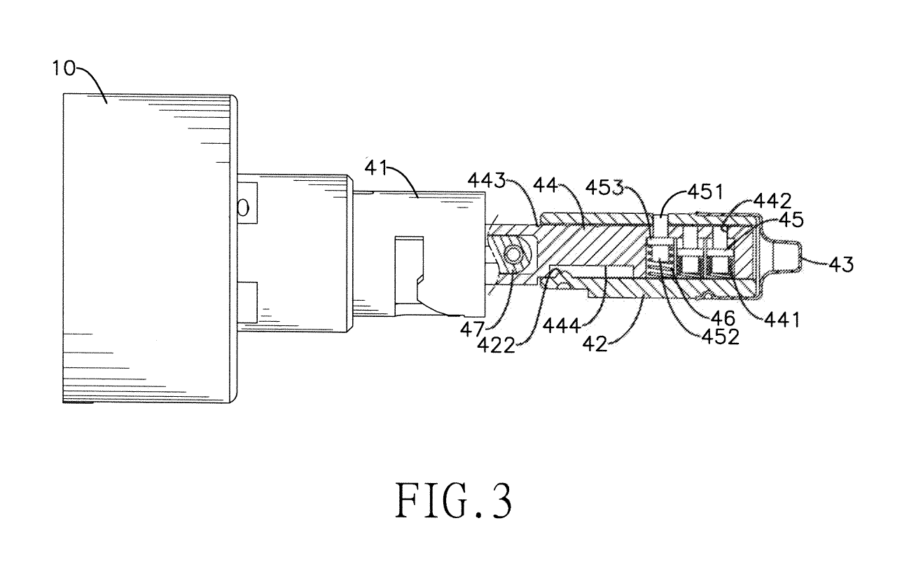

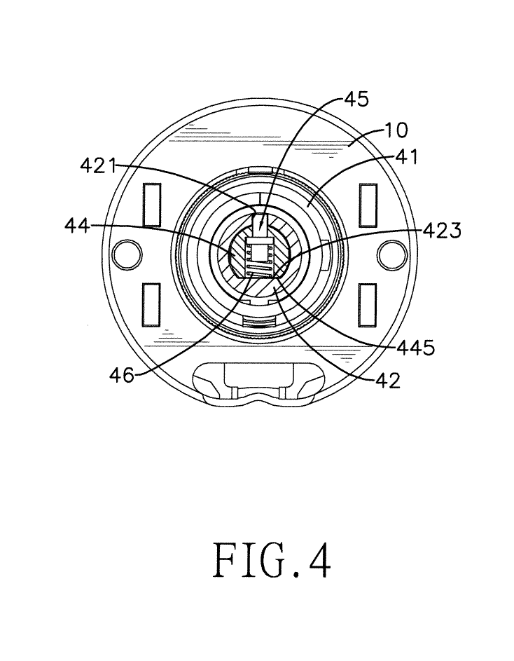

With further reference to FIGS. 3 and 4, the adjusting tube 42 is tubular, is mounted axially in the driving tube 41 and has an outer end, an inner end, a positioning hole 421, a flat portion 423 and a limiting protrusion 422. The inner end of the adjusting tube 42 corresponds to the lock body 10. The positioning hole 421 is formed radially through the adjusting tube 42. The flat portion 423 of the adjusting tube 42 is formed axially on an inner surface of the adjusting tube 42 so a channel that is D-shaped in cross-section is defined in the adjusting tube 42. The limiting protrusion 422 protrudes from the inner surface of the adjusting tube 42, protrudes from the flat portion 423 of the adjusting tube 42 and is disposed adjacent to the inner end of the adjusting tube 42.

The button 43 is mounted on the outer end of the adjusting tube 42 and protrudes out of the mounting tube 321 of the interior lever 32 to allow a user to hold the button 43 and operate the interior button assembly 40.

The driving rod 44 is slidably mounted axially in the adjusting tube 42 and has multiple mounting recesses 441, multiple through holes 442, multiple aligning marks 443, a flat portion 445 and a limiting groove 444. The mounting recesses 441 are separately formed radially in an outer surface of the driving rod 44 and are arranged axially along the driving rod 44. The through holes 442 are separately formed radially in the outer surface of the driving rod 44 and respectively communicate with the mounting recesses 441 of the driving rod 44. One of the through holes 442 of the driving rod 44 selectively aligns with the positioning hole 421 of the adjusting tube 42. The aligning marks 443 are separately formed in the outer surface of the driving rod 44, are arranged axially along the driving rod 44 and are disposed adjacent to an inner end of the driving rod 44. Distances between and relative positions of the aligning marks 443 correspond to distances between and relative positions of the through holes 442 of the driving rod 44. When one of the through holes 442 aligns with the positioning hole 421 of the adjusting tube 42, one of the aligning marks 443 is flush with the inner end of the adjusting tube 42 accordingly. Thus, according to positions of the aligning marks 443 relative to the inner end of the adjusting tube 42, the user knows positions of the positioning holes 421 of the adjusting tube 42 relative to the through holes 442 of the driving rod 44. The flat portion 445 of the driving rod 44 is formed axially on the outer surface of the driving rod 44 and corresponds to the flat portion 423 of the adjusting tube 42. Thus, the driving rod 44 is D-shaped in cross-section and the adjusting tube 42 is able to slide axially on the driving rod 44 and does not rotate relative to the driving rod 44. The limiting groove 444 is formed in the outer surface of the driving rod 44, is formed in the flat portion 445 of the driving rod 44, extends axially along the driving rod 44 and is mounted around the limiting protrusion 422 of the adjusting tube 42. Therefore, a sliding range of the adjusting tube 42 is limited so the adjusting tube 42 does not detach from the driving rod 44.

The positioning pins 45 are mounted respectively in the mounting recesses 441 of the driving rod 44. Each positioning pin 45 has a positioning end 451, a mounting end 452 and a flange 453. The positioning end 451 of the positioning pin 45 protrudes in a corresponding through hole 442 of the driving rod 44. The positioning end 451 of one of the positioning pins 45 further protrudes in the positioning hole 421 of the adjusting tube 42. The flange 453 is formed on an outer surface of the positioning pin 45, is disposed between the positioning end 451 and the mounting end 452 of the positioning pin 45, is mounted in a corresponding mounting recess 441 of the driving rod 44 and selectively abuts the driving rod 44.

The resilient elements 46 of the interior button assembly 40 are mounted respectively around the mounting end 452 of the positioning pin 45. Each resilient element 46 of the interior button assembly 40 has two ends respectively abutting the flange 453 of the positioning pin 45 and the inner surface of the adjusting tube 42.

The lock rod 47 is mounted through and selectively engages the lock body 10 and is connected securely to the inner end of the driving rod 44.

The exterior handle assembly 50 is connected to the lock body 10, is mounted on an exterior surface of the door and has an exterior cap 51, an exterior lever 52 and a lock core 53. The exterior cap 51 is mounted securely on the exterior surface of the door, corresponds to the lock body 10 and has a mounting hole formed through the exterior cap 51. The exterior lever 52 is mounted on an outer surface of the exterior cap 51 and has a mounting tube 521. The mounting tube 521 of the exterior lever 52 protrudes transversely from an end of the exterior lever 52 and is concentric with and communicates with the mounting hole of the exterior cap 51. The lock core 53 is mounted in the mounting tube 521 of the exterior lever 52 and has a keyhole formed in an outer end surface to allow a key 70 to be inserted into the keyhole of the lock core 53.

The exterior clutch assembly 60 is mounted in the exterior handle assembly 50, is connected to the lock body 10 and the mounting tube 521 of the exterior lever 52, and has an exterior driving tube 61, a transmission shaft 62, a transmission tube 63, a pressing panel 64, a resilient element 65 and a pusher 66.

The exterior driving tube 61 is tubular, is mounted through the mounting hole of the exterior cap 51 and has an outer end, an inner end and at least one guiding slot 611. The outer end of the exterior driving tube 61 corresponds to the lock core 53 of the exterior handle assembly 50 and is connected to the mounting tube 521 of the exterior lever 52. The at least one guiding slot 611 is formed through the exterior driving tube 61 and extends axially along the exterior driving tube 61.

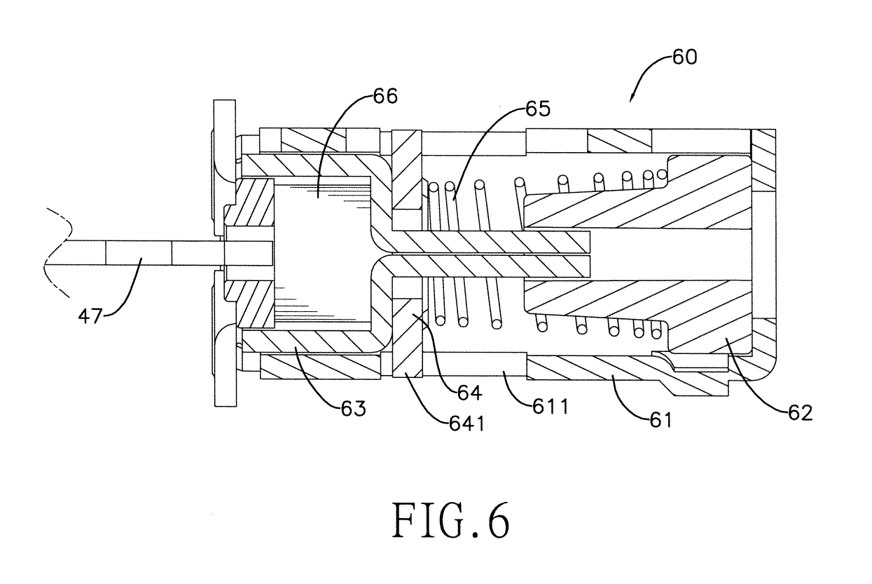

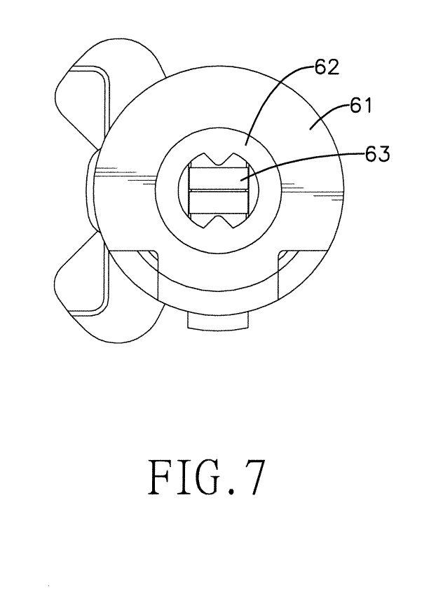

With further reference to FIGS. 6 and 7, the transmission shaft 62 is mounted in the exterior driving tube 61 and adjacent to the inner end of the exterior driving tube 61, and is connected to the lock core 53.

The transmission tube 63 is mounted in the exterior driving tube 61 adjacent to the outer end of the exterior driving tube 61, is connected to the transmission shaft 62 and the lock core 53 and has an outer end, an outer end edge and at least one positioning recess 631. The outer end edge of the transmission tube 63 is defined around the outer end of the transmission tube 63. The at least one positioning recess 631 is formed in the outer end edge of the transmission tube 63.

The pressing panel 64 is mounted on the outer end of the transmission tube 63 and has a peripheral edge and at least one positioning protrusion 641. The at least one positioning protrusion 641 is formed on and protrudes radially from the peripheral edge of the pressing panel 64, engages the at least one positioning recess 631 of the transmission tube 63 and the guiding slot 611 of the exterior driving tube 61. Thus, the exterior driving tube 61, the pressing panel 64 and the transmission tube 63 rotate simultaneously.

The resilient element 65 of the exterior clutch assembly 60 is mounted around the transmission shaft 62 and has two opposite ends respectively abutting the transmission shaft 62 and the pressing panel 64.

The pusher 66 is mounted in the transmission tube 63 adjacent to the inner end of the transmission tube 63 and has two opposite ends. One end of the pusher 66 abuts the pressing panel 64 and the other end of the pusher 66 is connected securely to the lock rod 47.

The tubular lever lock as described has the following advantages. When assembling the tubular lever lock on the door, the interior and exterior handle assemblies 30, 50 are mounted respectively on the interior and exterior surfaces of the door, and the user pushes the positioning pin 45 protruding in the positioning hole 421 of the adjusting tube 42 to disengage the adjusting tube 42 from the driving rod 44. Therefore, the adjusting tube 42 is slidable relative to the driving rod 44 and a total length of the adjusting tube 42 and the driving rod 44 is adjustable to match a thickness of the door.

Furthermore, referring to the aligning marks 443 of the driving rod 44, positions of the adjusting tube 42 relative to the driving rod 44 are efficiently and accurately adjusted to allow another positioning pin 45 to protrude in the positioning hole 421 of the adjusting tube 42. Thus, the total length of the adjusting tube 42 and the driving rod 44 is fixed. Consequently, the button 43 that is mounted on the outer end of the adjusting tube 42 properly protrudes out from the mounting tube 321 of the interior lever 32 to allow the user to hold the button 43 and operate the interior button assembly 40.

As for the exterior handle assembly 50 and the exterior clutch assembly 60, generally, when the exterior lever 52 is turned, the driving tube 61, the pressing panel 64 and the transmission tube 63 are turned simultaneously. Then, the transmission tube 63 drives the lock body 10 and the blot 20 to unlock the door.

When the user is standing by the interior surface of the door and pushes the button 43 of the interior button assembly 40, the adjusting tube 42, the driving rod 44 and the lock rod 47 are pushed toward the exterior clutch assembly 60, and the lock rod 47 further pushes the pusher 66 and pressing panel 64. Therefore, the pressing panel 64 presses the resilient element 65 of the exterior clutch assembly 60, and the at least one positioning protrusion 641 of the pressing panel 64 disengages from the at least one positioning recess 631 of the transmission tube 63. As the lock rod 47 engages the lock body 10, the at least one positioning protrusion 641 of the pressing panel 64 disengages from the at least one positioning recess 631 of the transmission tube 63.

Moreover, the user may further turn the interior button assembly 40 to allow the at least one positioning protrusion 641 of the pressing panel 64 and the at least one positioning recess 631 of the transmission tube 63 to misalign with each other, and the outer end edge of the transmission tube 63 abuts the pressing panel 64. By doing so, as the exterior lever 52 is turned, the exterior lever 52 only drives the exterior driving tube 61 and the pressing panel 64 and does not drive the transmission tube 63. Consequently, the exterior lever 52 is unable to drive the lock body 10 and the bolt 20 to unlock the door.

Then, when a key 70 is inserted into the keyhole of the lock core 53, and when the key 70 and the lock core 53 are turned, the transmission shaft 62 and the transmission tube 63 are turned simultaneously to allow the transmission tube 63 to drive the lock body 10 and the bolt 20 and unlock the door.

Afterwards, when the user pulls the interior button assembly 40 to disengage the lock rod 47 from the lock body 10, the resilient element 65 of the exterior clutch assembly 60 pushes back the pressing panel 64 and the pusher 66.

The at least one positioning protrusion 641 of the pressing panel 64 engages the at least one positioning recess 631 of the transmission tube 63 again. The exterior lever 52 is able to drive the lock body 10 and the bolt 20 to unlock the door.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A tubular lever lock comprising
a lock body;
a bolt connected to the lock body;
an interior handle assembly connected to the lock body and having
an interior cap having a mounting hole formed through the interior cap; and
an interior lever mounted on an outer surface of the interior cap and having a mounting tube protruding transversely from an end of the interior lever and being concentric with and communicating with the mounting hole of the interior cap; and
an interior button assembly mounted in the interior handle assembly, connected to the lock body and the interior lever, and having
an interior driving tube mounted through the mounting hole of the interior cap and connected to the mounting tube of the interior lever and the lock body;
an adjusting tube mounted axially in the driving tube and having
an outer end;
an inner end corresponding to the lock body; and
a positioning hole formed radially through the adjusting tube;
a button mounted on the outer end of the adjusting tube and protruding out of the mounting tube of the interior lever;
a driving rod slidably mounted axially in the adjusting tube and having
multiple mounting recesses separately formed radially in an outer surface of the driving rod and arranged axially along the driving rod; and
multiple through holes separately formed radially in the outer surface of the driving rod and respectively communicating with the mounting recesses of the driving rod, and one of the through holes of the driving rod selectively aligning with the positioning hole of the adjusting tube;
multiple positioning pins mounted respectively in the mounting recesses of the driving rod, and each positioning pin having
a positioning end protruding in a corresponding through hole of the driving rod, and the positioning end of one of the positioning pins protruding in the positioning hole of the adjusting tube;
a mounting end; and
a flange formed on an outer surface of the positioning pin, disposed between the positioning end and the mounting end of the positioning pin, mounted in a corresponding mounting recess of the driving rod and selectively abutting the driving rod;
multiple resilient elements mounted respectively around the mounting end of the positioning pin, and each resilient element of the interior button assembly having two ends respectively abutting the flange of the positioning pin and an inner surface of the adjusting tube; and
a lock rod mounted through and selectively engaging the lock body and connected securely to the inner end of the driving rod.

2. The tubular lever lock as claimed in claim 1 further comprising
an exterior handle assembly connected to the lock body and having
an exterior cap having a mounting hole formed through the exterior cap;
an exterior lever mounted on an outer surface of the exterior cap and having a mounting tube protruding transversely from an end of the exterior lever and being concentric with and communicating with the mounting hole of the exterior cap; and
a lock core mounted in the mounting tube of the exterior lever; and
an exterior clutch assembly mounted in the exterior handle assembly, connected to the lock body and the mounting tube of the exterior lever, and having
an exterior driving tube mounted through the mounting hole of the exterior cap and having
an outer end corresponding to the lock core of the exterior handle assembly and connected to the mounting tube of the exterior lever;
an inner end; and
at least one guiding slot formed through the exterior driving tube and extending axially along the exterior driving tube;
a transmission shaft mounted in the exterior driving tube and adjacent to the inner end of the exterior driving tube, and connected to the lock core:
a transmission tube mounted in the exterior driving tube adjacent to the outer end of the exterior driving tube, connected to the transmission shaft and the lock core and having
an outer end;
an outer end edge defined around the outer end of the transmission tube; and
at least one positioning recess formed in the outer end edge of the transmission tube;
a pressing panel mounted on the outer end of the transmission tube and having
a peripheral edge; and
at least one positioning protrusion formed on and protruding radially from the peripheral edge of the pressing panel, engaging the at least one positioning recess of the transmission tube and the guiding slot of the exterior driving tube;
a resilient element mounted around the transmission shaft and having two opposite ends respectively abutting the transmission shaft and the pressing panel; and
a pusher mounted in the transmission tube adjacent to the inner end of the transmission tube and having two opposite ends, and one end of the pusher abutting the pressing panel and the other end of the pusher connected securely to the lock rod.

3. The tubular lever lock as claimed in claim 1, wherein
the adjusting tube of the interior button assembly further has a limiting protrusion protruding from the inner surface of the adjusting tube and disposed adjacent to the inner end of the adjusting tube; and
the driving rod of the interior button assembly further has a limiting groove formed in the outer surface of the driving rod, extending axially along the driving rod and mounted around the limiting protrusion of the adjusting tube.

4. The tubular lever lock as claimed in claim 2, wherein
the adjusting tube of the interior button assembly further has a limiting protrusion protruding from the inner surface of the adjusting tube and disposed adjacent to the inner end of the adjusting tube; and
the driving rod of the interior button assembly further has a limiting groove formed in the outer surface of the driving rod, extending axially along the driving rod and mounted around the limiting protrusion of the adjusting tube.

5. The tubular lever lock as claimed in claim 1, wherein
the driving rod of the interior button assembly further has multiple aligning marks separately formed in the outer surface of the driving rod, arranged axially along the driving rod and disposed adjacent to an inner end of the driving rod; and
distances between and relative positions of the aligning marks correspond to distances between and relative positions of the through holes of the driving rod.

6. The tubular lever lock as claimed in claim 2, wherein
the driving rod of the interior button assembly further has multiple aligning marks separately formed in the outer surface of the driving rod, arranged axially along the driving rod and disposed adjacent to an inner end of the driving rod; and
distances between and relative positions of the aligning marks correspond to distances between and relative positions of the through holes of the driving rod.

7. The tubular lever lock as claimed in claim 3, wherein
the driving rod of the interior button assembly further has multiple aligning marks separately formed in the outer surface of the driving rod, arranged axially along the driving rod and disposed adjacent to an inner end of the driving rod; and
distances between and relative positions of the aligning marks correspond to distances between and relative positions of the through holes of the driving rod.

8. The tubular lever lock as claimed in claim 4, wherein
the driving rod of the interior button assembly further has multiple aligning marks separately formed in the outer surface of the driving rod, arranged axially along the driving rod and disposed adjacent to an inner end of the driving rod; and
distances between and relative positions of the aligning marks correspond to distances between and relative positions of the through holes of the driving rod.

9. The tubular lever lock as claimed in claim 1, wherein
the adjusting tube of the interior button assembly further has a flat portion formed axially on the inner surface of the adjusting tube;
the limiting protrusion of the adjusting tube protrudes from the flat portion of the adjusting tube;
the driving rod of the interior button assembly further has a flat portion formed axially on the outer surface of the driving rod and corresponding to the flat portion of the adjusting tube; and
the limiting groove of the driving rod is formed in the flat portion of the driving rod.

10. The tubular lever lock as claimed in claim 2, wherein
the adjusting tube of the interior button assembly further has a flat portion formed axially on the inner surface of the adjusting tube;
the limiting protrusion of the adjusting tube protrudes from the flat portion of the adjusting tube;
the driving rod of the interior button assembly further has a flat portion formed axially on the outer surface of the driving rod and corresponding to the flat portion of the adjusting tube; and
the limiting groove of the driving rod is formed in the flat portion of the driving rod.

11. The tubular lever lock as claimed in claim 3, wherein
the adjusting tube of the interior button assembly further has a flat portion formed axially on the inner surface of the adjusting tube;
the limiting protrusion of the adjusting tube protrudes from the flat portion of the adjusting tube;
the driving rod of the interior button assembly further has a flat portion formed axially on the outer surface of the driving rod and corresponding to the flat portion of the adjusting tube; and
the limiting groove of the driving rod is formed in the flat portion of the driving rod.

12. The tubular lever lock as claimed in claim 4, wherein
the adjusting tube of the interior button assembly further has a flat portion formed axially on the inner surface of the adjusting tube;
the limiting protrusion of the adjusting tube protrudes from the flat portion of the adjusting tube;
the driving rod of the interior button assembly further has a flat portion formed axially on the outer surface of the driving rod and corresponding to the flat portion of the adjusting tube; and
the limiting groove of the driving rod is foinied in the flat portion of the driving rod.

13. The tubular lever lock as claimed in claim 5, wherein
the adjusting tube of the interior button assembly further has a flat portion formed axially on the inner surface of the adjusting tube;
the limiting protrusion of the adjusting tube protrudes from the flat portion of the adjusting tube;
the driving rod of the interior button assembly further has a flat portion formed axially on the outer surface of the driving rod and corresponding to the flat portion of the adjusting tube; and
the limiting groove of the driving rod is formed in the flat portion of the driving rod.

14. The tubular lever lock as claimed in claim 6, wherein
the adjusting tube of the interior button assembly further has a flat portion formed axially on the inner surface of the adjusting tube;
the limiting protrusion of the adjusting tube protrudes from the flat portion of the adjusting tube;
the driving rod of the interior button assembly further has a flat portion formed axially on the outer surface of the driving rod and corresponding to the flat portion of the adjusting tube; and
the limiting groove of the driving rod is formed in the flat portion of the driving rod.

15. The tubular lever lock as claimed in claim 7, wherein
the adjusting tube of the interior button assembly further has a flat portion formed axially on the inner surface of the adjusting tube;
the limiting protrusion of the adjusting tube protrudes from the flat portion of the adjusting tube;
the driving rod of the interior button assembly further has a flat portion formed axially on the outer surface of the driving rod and corresponding to the flat portion of the adjusting tube; and
the limiting groove of the driving rod is formed in the flat portion of the driving rod.

16. The tubular lever lock as claimed in claim 8, wherein
the adjusting tube of the interior button assembly further has a flat portion formed axially on the inner surface of the adjusting tube;
the limiting protrusion of the adjusting tube protrudes from the flat portion of the adjusting tube;
the driving rod of the interior button assembly further has a flat portion formed axially on the outer surface of the driving rod and corresponding to the flat portion of the adjusting tube; and
the limiting groove of the driving rod is formed in the flat portion of the driving rod.
